(19) United States
(12) Patent Application Publication
(10) Pub. No.: US 2025/0392220 A1
(43) Pub. Date: Dec. 25, 2025

(54) BIDIRECTIONAL NON-ISOLATED DC-DC CONVERTER AND METHOD OF OPERATING THE SAME

(71) Applicant: HANWHA SOLUTIONS CORPORATION, Seoul (KR)

(72) Inventor: Duk Hyeon YUN, Seoul (KR)

(21) Appl. No.: 19/214,117

(22) Filed: May 21, 2025

(30) Foreign Application Priority Data
Jun. 24, 2024 (KR) 10-2024-0082251

(51) Int. Cl. H02M 3/158; H02M 1/00

(52) U.S. Cl. CPC H02M 3/158; H02M 1/0058

(57) ABSTRACT

Provided is a bidirectional non-isolated direct current-to-direct current (DC-DC) converter including a first voltage stage configured to generate a first voltage, a second voltage stage configured to generate a voltage higher than the first voltage, an inductor connected to the first voltage stage, a switching module including four switching devices connected in series, and configured to generate a three-level voltage through selective switching operations of each of the four switching devices, a zero-voltage switching inductor configured to induce zero-voltage switching of main switching devices included in the switching module, and an output capacitor module connected to the second voltage stage and configured to halve the output voltage.

### CROSS-REFERENCE TO RELATED APPLICATION

This application is based on and claims priority under 35 U.S.C. § 119 to Korean Patent Application No. 10-2024-0082251, filed on Jun. 24, 2024, in the Korean Intellectual Property Office, the disclosure of which is incorporated by reference herein in its entirety.

### BACKGROUND

### 1. Field

The present disclosure relates to a bidirectional non-isolated direct current-to-direct current (DC-DC) converter and a method of operating the same.

### 2. Description of the Related Art

Photovoltaic (PV) inverters use bidirectional direct current-to-direct current (DC-DC) converters to charge and discharge batteries. The specifications of a typical battery range from 30 V to 264 V depending on a charge state of the battery, and a DC link voltage of an inverter ranges from 400 V to 600 V, and thus, bidirectional DC-DC converters are used to convert a voltage between a minimum of 30 V and a maximum of 600 V.

Bidirectional DC-DC converters previously used in the industry are typically classified based on whether input and output are isolated, with representative types including buck-boost converters and dual active bridge (DAB) converters, while non-isolated bidirectional buck-boost converters are widely used to address cost reduction and power density requirements.

The recent trend in the photovoltaic inverter industry demands high power density, reduced weight, improved efficiency, and lower switching noise, and to meet these requirements, conventional technologies focusing on high power density may employ bidirectional three-level buck-boost converters, which adopt three-level switching to reduce the size of passive components and lower the voltage stress on switching devices.

However, conventional technology is insufficient to improve the efficiency and reduce the noise of three-level buck-boost converters, and thus there is a need for further technological development.

The aforementioned background technology is technical information possessed by the inventor for derivation of the present disclosure or acquired by the inventor during the derivation of the present disclosure, and is not necessarily prior art disclosed to the public before the application of the present disclosure.

### SUMMARY

Some embodiments of the present disclosure are directed to providing a bidirectional non-isolated direct current-to-direct current (DC-DC) converter and a method of operating the same. The problem to be solved by the present disclosure is not limited to the above-mentioned problem, and other problems and advantages of the present disclosure not mentioned may be understood by the following description and more clearly understood by the embodiments of the present disclosure. Further, it will be appreciated that the problems and advantages to be solved by the present disclosure may be realized by means and combinations thereof indicated in the claims.

According to an aspect of the present disclosure, there is provided a bidirectional non-isolated direct current-to-direct current (DC-DC) converter including a first voltage stage configured to generate a first voltage, a second voltage stage configured to generate a voltage higher than the first voltage, an inductor connected to the first voltage stage, a switching module including four switching devices connected in series, and configured to generate a three-level voltage through selective switching operations of each of the four switching devices, a zero-voltage switching inductor configured to induce zero-voltage switching of main switching devices included in the switching module, and an output capacitor module connected to the second voltage stage and configured to halve the output voltage.

According to a second aspect of the present disclosure, there is provided a method of operating a bidirectional non-isolated direct current-to-direct current (DC-DC) converter operating in a boost mode, including operating the bidirectional non-isolated DC-DC converter in a sixth operating mode based on turn-on of a first switching device that has a turn-on duty ratio of less than 0.5, operating the bidirectional non-isolated DC-DC converter in a first operating mode based on a magnitude of a current flowing through an inductor becoming equal to a magnitude of a current flowing through a zero-voltage switching inductor, while the first switching device remains turned on, operating the bidirectional non-isolated DC-DC converter in a second operating mode based on turn-off of the first switching device, operating the bidirectional non-isolated DC-DC converter in a third operating mode based on turn-on of a second switching device that has the turn-on duty ratio of less than 0.5, operating the bidirectional non-isolated DC-DC converter in a fourth operating mode based on the magnitude of the current flowing through the inductor becoming equal to the magnitude of the current flowing through a zero-voltage switching inductor, while the second switching device remains turned on, and operating the bidirectional non-isolated DC-DC converter in a fifth operating mode based on turn-off of the second switching device.

According to a third aspect of the present disclosure, there is provided a method of operating a bidirectional non-isolated direct current-to-direct current (DC-DC) converter operating in a boost mode, including operating the bidirectional non-isolated DC-DC converter in a fifth operating mode based on turn-off of a first switching device having a turn-on duty ratio of greater than 0.5, while a second switching device having the turn-on duty ratio of greater than 0.5 is in a turn-on state, operating the bidirectional non-isolated DC-DC converter in a sixth operating mode based on a magnitude of a current flowing through an inductor becoming equal to a magnitude of a current flowing through a zero-voltage switching inductor, while the first switching device is in the turn-on state and the second switching device is in a turn-off state, operating the bidirectional non-isolated DC-DC converter in a first operating mode based on turn-on of the second switching device, while the first switching device is in the turn-on state, operating the bidirectional non-isolated DC-DC converter in a second operating mode based on turn-off of the first switching device, while the second switching device is in the turn-on state, operating the bidirectional non-isolated DC-DC converter in a third operating mode based on the magnitude of the current flowing through the inductor becoming equal to the magnitude of the current flowing through the zero-voltage switching inductor, while the first switching device is in the turn-off state and the second switching device is in the turn-on state, and operating the bidirectional non-isolated DC-DC converter in a fourth operating mode based on turn-on of the first switching device, while the second switching device is in the turn-on state.

According to a fourth aspect of the present disclosure, there is provided a method of operating a bidirectional non-isolated direct current-to-direct current (DC-DC) converter operating in a buck mode, including operating the bidirectional non-isolated DC-DC converter in a sixth operating mode based on turn-on of a third switching device that has a turn-on duty ratio of less than 0.5, operating the bidirectional non-isolated DC-DC converter in a first operating mode based on a magnitude of a current flowing through an inductor becoming equal to a magnitude of a current flowing through a zero-voltage switching inductor, while the third switching device remains turned on, operating the bidirectional non-isolated DC-DC converter in a second operating mode based on turn-off of the third switching device, operating the bidirectional non-isolated DC-DC converter in a third operating mode based on turn-on of a fourth switching device that has the turn-on duty ratio of less than 0.5, operating the bidirectional non-isolated DC-DC converter in a fourth operating mode based on the magnitude of the current flowing through the inductor becoming equal to the magnitude of the current flowing through a zero-voltage switching inductor, while the fourth switching device remains turned on, and operating the bidirectional non-isolated DC-DC converter in a fifth operating mode based on turn-off of the fourth switching device.

According to a fifth aspect of the present disclosure, there is provided a method of operating a bidirectional non-isolated direct current-to-direct current (DC-DC) converter operating in a buck mode, including operating the bidirectional non-isolated DC-DC converter in a fifth operating mode based on turn-off of a third switching device having a turn-on duty ratio of greater than 0.5, while a fourth switching device having the turn-on duty ratio of greater than 0.5 is in a turn-on state, operating the bidirectional non-isolated DC-DC converter in a sixth operating mode based on a magnitude of a current flowing through an inductor becoming equal to a magnitude of a current flowing through a zero-voltage switching inductor, while the third switching device is in the turn-on state and the fourth switching device is in a turn-off state, operating the bidirectional non-isolated DC-DC converter in a first operating mode based on turn-on of the fourth switching device, while the third switching device is in the turn-on state, operating the bidirectional non-isolated DC-DC converter in a second operating mode based on turn-off of the third switching device, while the fourth switching device is in the turn-on state, operating the bidirectional non-isolated DC-DC converter in a third operating mode based on the magnitude of the current flowing through the inductor becoming equal to the magnitude of the current flowing through the zero-voltage switching inductor, while the third switching device is in the turn-off state and the fourth switching device is in the turn-on state, and operating the bidirectional non-isolated DC-DC converter in a fourth operating mode based on turn-on of the third switching device, while the fourth switching device is in the turn-on state.

Other aspects, features, and advantages other than those described above will become apparent from the following drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a circuit diagram for describing a direct current-to-direct current (DC-DC) converter according to an embodiment of the present disclosure;

FIG. 2 is a drawing for describing a method of operating the DC-DC converter according to an embodiment of the present disclosure;

FIG. 3 is a drawing for describing a method of operating the DC-DC converter according to another embodiment of the present disclosure;

FIG. 4 is a drawing for describing a method of operating the DC-DC converter according to another embodiment of the present disclosure;

FIG. 5 is a diagram illustrating a plurality of waveforms of the DC-DC converter according to an embodiment of the present disclosure;

FIG. 6 is a diagram illustrating a plurality of waveforms of the DC-DC converter according to an embodiment of the present disclosure;

FIG. 7 is a diagram illustrating a plurality of waveforms of the DC-DC converter according to an embodiment of the present disclosure;

FIG. 8 is a diagram illustrating a plurality of waveforms of the DC-DC converter according to an embodiment of the present disclosure;

FIG. 9 is a drawing for describing a method of operating the DC-DC converter according to an embodiment of the present disclosure;

FIG. 10 is a drawing for describing a method of operating the DC-DC converter according to another embodiment of the present disclosure;

FIG. 11 is a drawing for describing a method of operating the DC-DC converter according to another embodiment of the present disclosure;

FIG. 12 is a diagram illustrating a plurality of waveforms of the DC-DC converter according to an embodiment of the present disclosure;

FIG. 13 is a diagram illustrating a plurality of waveforms of the DC-DC converter according to an embodiment of the present disclosure;

FIG. 14 is a flowchart for describing a method of operating the DC-DC converter according to an embodiment of the present disclosure;

FIG. 15 is a flowchart for describing a method of operating the DC-DC converter according to another embodiment of the present disclosure;

FIG. 16 is a flowchart for describing a method of operating the DC-DC converter according to another embodiment of the present disclosure; and

FIG. 17 is a flowchart for describing a method of operating the DC-DC converter according to another embodiment of the present disclosure.

### DETAILED DESCRIPTION

The effects and features of the present disclosure and the accompanying methods thereof will become apparent from the following description of the embodiments, taken in conjunction with the accompanying drawings. However, it should be understood that the present disclosure is not limited to the embodiments presented below, but may be implemented in various other forms and includes all transformations, equivalents, and substitutes included in the spirit and scope of the present disclosure. It should be understood, however, that the description of the embodiments is provided to enable the present disclosure to be complete, and will fully convey the scope of the disclosure to one of ordinary skill in the art to which the present disclosure belongs. In describing the present disclosure, when it is determined that a detailed description of a related known technology may obscure the gist of the present disclosure, the detailed description thereof will be omitted.

The terms used in the present specification are used to describe only specific embodiments or examples, and are not intended to limit the present disclosure. Unless otherwise defined, all terms used herein have the same meanings as those commonly understood by one of ordinary skill in the art to which the present disclosure belongs.

In the present specification, singular forms are intended to include plural forms as well, unless the context clearly indicates otherwise. Further, the terms “include” or “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

Further, terms including ordinal numbers such as “first” or “second” used herein may be used to describe various components, but the components should not be limited by the terms. These terms are used only for the purpose of distinguishing one component from another component.

Phrases such as “in an embodiment,” “according to an embodiment,” “relating to an embodiment,” “according to one embodiment implementation,” and the like appearing in various places in the present specification are not necessarily all referring to the same embodiment. Further, throughout the specification, “embodiment” is a random division for easily describing the present disclosure, and each embodiment need not be mutually exclusive. For example, configurations mentioned for the purpose of describing one embodiment may be applied and implemented in other embodiments and may be changed and applied and implemented without departing from the idea and scope of the present disclosure.

Some embodiments of the present disclosure may be represented by functional block configurations and various processing operations. Some or all of these functional blocks may be implemented by various numbers of hardware and/or software configurations that perform particular functions. For example, the functional blocks of the present disclosure may be implemented by one or more microprocessors or by circuit configurations for a certain function.

For example, the functional blocks of the present disclosure may be implemented in various programming or scripting languages. The functional blocks may be implemented by algorithms executed in one or more processors. In addition, the present disclosure may employ conventional techniques for electronic environment setting, signal processing, and/or data processing. Terms such as “mechanism,” “element,” “means,” and “configuration” can be used broadly and are not limited to mechanical and physical configurations. Further, terms such as “-unit” and “-module” denote a unit that processes at least one function or operation, which may be implemented in hardware or software, or implemented in a combination of hardware and software.

Further, a connection line or a connection member between components shown in the drawings is merely a functional connection and/or a physical or circuit connection. In an actual device, connections between components may be represented by various functional connections, physical connections, or circuit connections that are replaceable or added.

In addition, some components in the drawings may be shown to be exaggerated in size or proportion. Further, components shown in one drawing may not be shown in other drawings.

Hereinafter, the present disclosure will be described in detail with reference to the accompanying drawings.

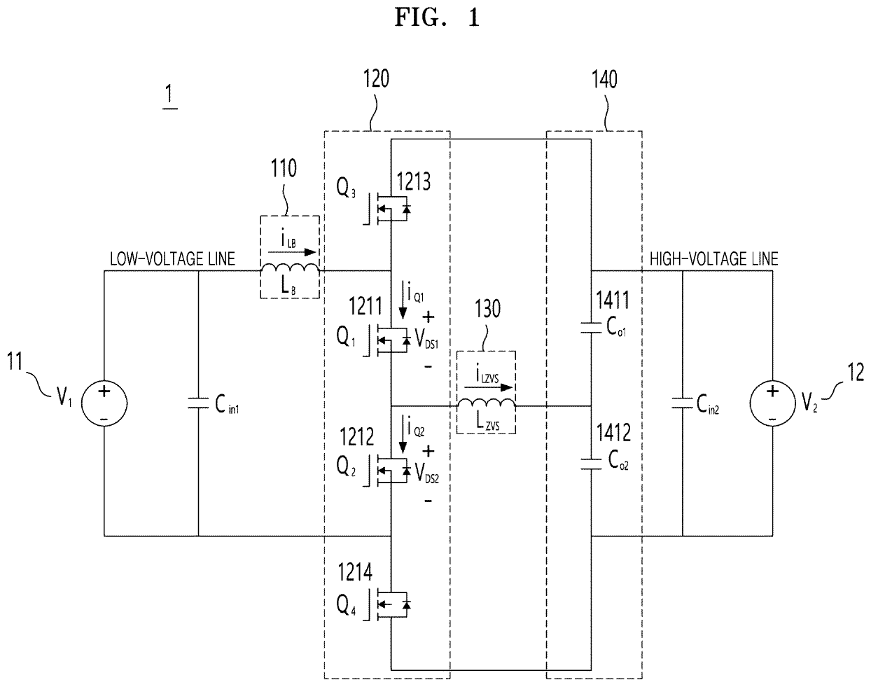

FIG. 1 is a circuit diagram for describing a direct current-to-direct current (DC-DC) converter according to an embodiment of the present disclosure.

The DC-DC converter according to an embodiment of the present disclosure is a bidirectional converter that can operate in a boost mode, which outputs a voltage higher than an input voltage, and a buck mode, which outputs a voltage lower than the input voltage.

Referring to FIG. 1, a DC-DC converter 1 according to an embodiment may include a first voltage stage 11, an inductor 110, a switching module 120, a zero-voltage switching inductor 130, an output capacitor module 140, and a second voltage stage 12.

In an embodiment, the second voltage stage 12 may generate a second voltage that is higher than a first voltage generated by the first voltage stage 11. That is, when the first voltage stage 11 is described as a low-voltage line, the second voltage stage 12 may be described as a high-voltage line that generates a relatively high voltage.

In an embodiment, when the DC-DC converter 1 operates in the boost mode, the first voltage stage 11 may serve as an input stage that generates a low voltage. In this case, the second voltage stage 12 may serve as an output stage that outputs a high voltage. When the DC-DC converter 1 operates in the buck mode, the second voltage stage 12 may serve as an input stage that generates a high voltage, and the first voltage stage 11 may serve as an output stage that outputs a low voltage.

Referring to the circuit diagram of FIG. 1, the inductor 110 may be connected to the first voltage stage 11. Further, the inductor 110 may be connected to a connection point between a first switching device 1211 and a third switching device 1213, which are included in the switching module 120.

In an embodiment, the inductor 110 may transfer a voltage supplied from the first voltage stage 11 to the second voltage stage 12. For example, when the DC-DC converter 1 operates in the boost mode, the inductor 110 may store (or charge) the voltage supplied from the first voltage stage 11 and release the voltage toward the second voltage stage 12.

In another embodiment, the inductor 110 may transfer a voltage supplied from the second voltage stage 12 to the first voltage stage 11. For example, when the DC-DC converter 1 operates in the buck mode, the inductor 110 may reduce ripple of the voltage supplied from the second voltage stage 12 and transmit the voltage to the first voltage stage 11.

Referring again to the circuit diagram of FIG. 1, the switching module 120 may include four switching devices.

In an embodiment, a first switching device 1211 (Q1), a second switching device 1212 (Q2), a third switching device 1213 (Q3), and a fourth switching device 1214 (Q4), which are included in the switching module 120, may be connected in series.

In an embodiment, the first to fourth switching devices 1211 to 1214 may be transistors. For example, the first to fourth switching devices 1211 to 1214 may be negative (n)-type transistors.

In an embodiment, the switching devices included in the switching module 120 may operate based on a pulse-width modulation (PWM) method at a certain switching frequency. In some embodiments, the first switching device 1211 and the second switching device 1212 may operate complementarily to each other, and the third switching device 1213 and the fourth switching device 1214 may also operate complementarily to each other.

For example, in an embodiment, when the DC-DC converter operates in the boost mode or the buck mode, gating signals of the switching devices operating as main switching devices in each mode may have a 180-degree phase difference.

In some embodiments, the switching module 120 may generate a three-level voltage by selectively operating each switching device.

For example, when the DC-DC converter 1 operates in the boost mode, the first switching device 1211 and the second switching device 1212 may be turned on or turned off as main switching devices. When the DC-DC converter 1 operates in the buck mode, the third switching device 1213 and the fourth switching device 1214 may be turned on or turned off as main switching devices. A detailed description of the operation of each switching device according to the operating mode of the DC-DC converter 1 will be provided later.

Referring again to the circuit diagram of FIG. 1, the zero-voltage switching inductor 130 may have one end connected to a connection point between the first switching device 1211 and the second switching device 1212, which are included in the switching module 120.

The zero-voltage switching inductor 130 may have another end connected to a connection point between output capacitors included in the output capacitor module 140. For example, the zero-voltage switching inductor 130 may be connected to a connection point between a first output capacitor 1411 and a second output capacitor 1412, which are included in the output capacitor module 140.

The zero-voltage switching inductor 130 may induce zero-voltage switching (ZVS) of the main switching devices included in the switching module. In more detail, embodiments of the present disclosure in which the zero-voltage switching inductor 130 operates will be described later.

The output capacitor module 140 may be connected to the second voltage stage 12.

In an embodiment, the output capacitor module 140 may divide an output voltage. For example, when the output capacitor module 140 is configured with two capacitors 1411 and 1412 connected in series, the output voltage may be divided into half by the two capacitors 1411 and 1412.

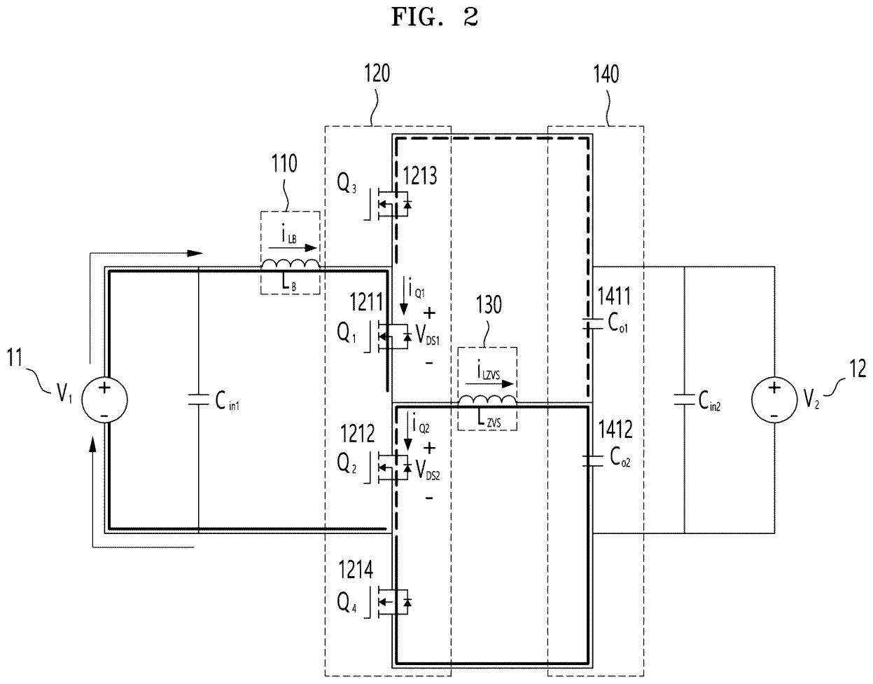

Hereinafter, a method of operating the DC-DC converter 1 according to an embodiment of the present disclosure will be described with reference to FIGS. 2 to 17.

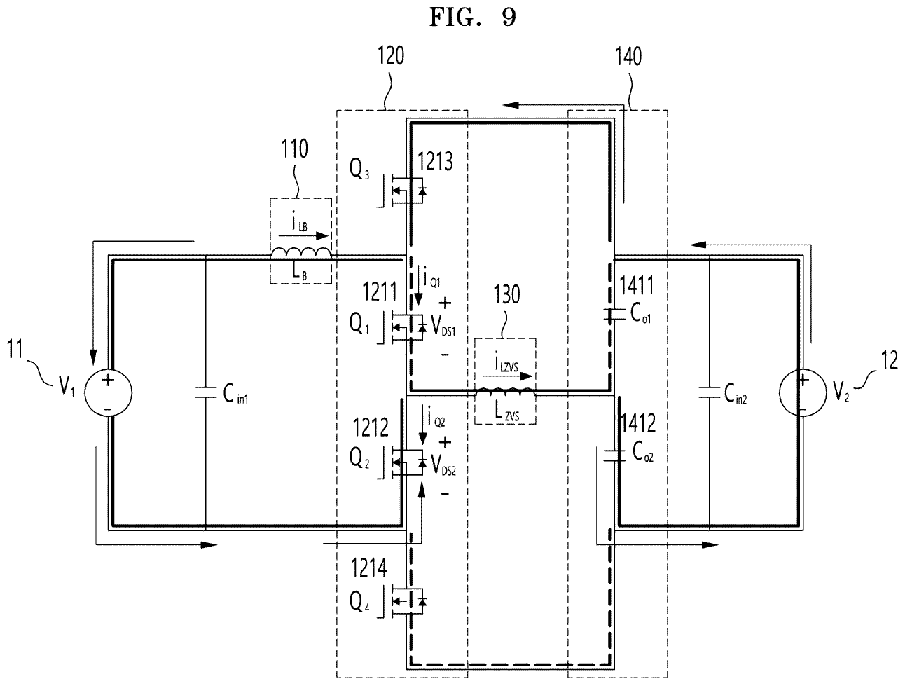

In the present disclosure, operating modes of the DC-DC converter 1 are classified into a boost mode and a buck mode and will be described separately. The boost mode will be described with reference to FIGS. 2 to 8, and the buck mode will be described with reference to FIGS. 9 to 13. However, since the operating principle of the switching devices in the DC-DC converter 1 may be the same in the descriptions of the boost mode and the buck mode, redundant descriptions will be omitted.

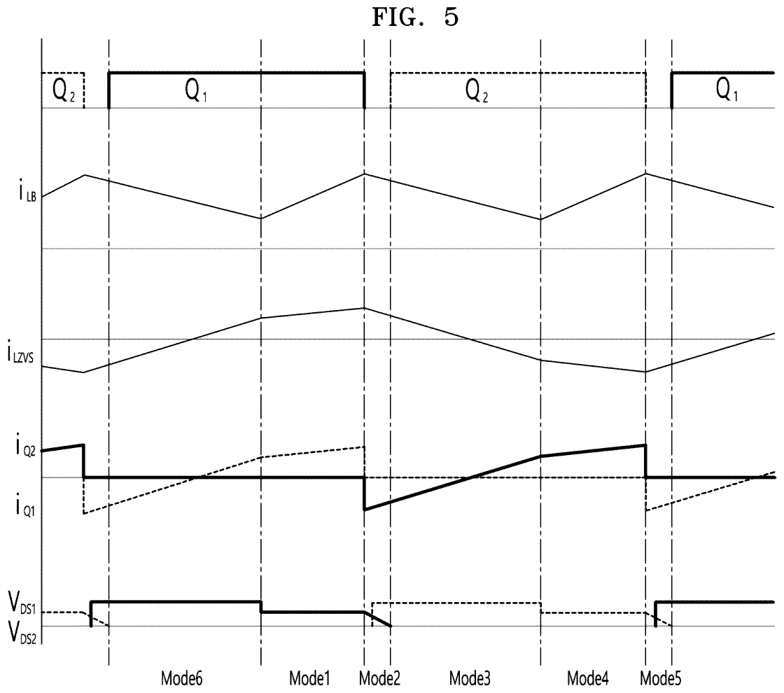

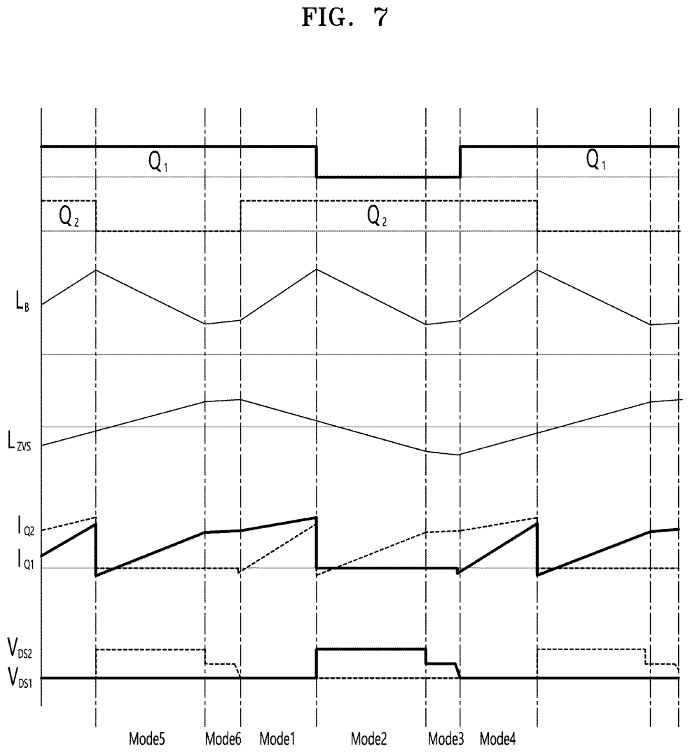

Further, the present embodiment describes embodiments of the method of operating the DC-DC converter 1 based on duty ratios of the main switching devices. FIGS. 5, 6, and 12 (buck mode) illustrate examples of waveforms and simulation results of the DC-DC converter 1 for an embodiment in which the duty ratio of each main switching device is less than 0.5, and FIGS. 7, 8, and 13 (buck mode) correspond to examples of waveforms and simulation results of the DC-DC converter 1 for an embodiment in which the duty ratio of each main switching device is greater than 0.5.

FIGS. 2 to 4 are diagrams for describing current flow when the DC-DC converter operates in the boost mode, in an embodiment of the present disclosure. FIGS. 5 to 8 are diagrams for describing waveforms when the DC-DC converter operates in the boost mode.

In the present disclosure, the DC-DC converter 1 operating in the boost mode may operate in six operating modes depending on turn-on or turn-off of the main switching devices.

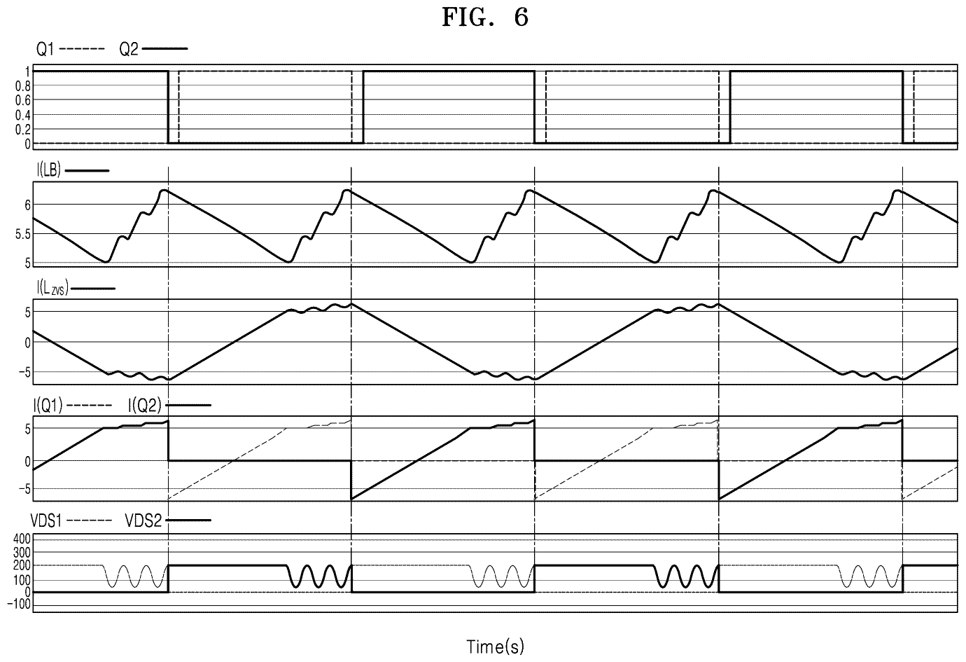

In more detail, FIG. 5 illustrates an example of waveforms of the DC-DC converter when a duty ratio of each main switching device is less than 0.5 (i.e., when the sum of the duty ratios of the main switching devices is less than 1), and FIG. 6 illustrates an example of actual simulation results of the waveforms of the DC-DC converter.

The following describes a case in which the DC-DC converter operates in a sixth operating mode (Mode 6) (see FIG. 5).

Referring to FIG. 5, Mode 6 may be initiated based on turn-on of the first switching device 1211.

In Mode 6, the first switching device 1211, which is the main switching device in the boost mode, is turned on, and the second switching device 1212 may be in a turn-off state. The third switching device 1213 and the fourth switching device 1214, which are not the main switching devices in the boost mode, may be in a turn-off state.

Referring to FIG. 2, based on the turn-on of the first switching device 1211, a current supplied from both ends of the first voltage stage 11 may pass through the inductor 110, flow through the first switching device 1211, and pass through the zero-voltage switching inductor 130. Subsequently, the current may pass through the second output capacitor 1412, flow through a body diode of the fourth switching device 1214, and then flow to a negative terminal of the first voltage stage 11.

In Mode 6, a magnitude of a current i_{LB} flowing through the inductor 110 may have a negative slope. A current i_{LZVS} flowing through the zero-voltage switching inductor 130 and a current i_{Q1} flowing through the first switching device 1211 may have a positive slope.

### Description of First Operating Mode (see FIG. 5)

Referring to FIG. 5, Mode 1 may be initiated based on the magnitude of the current i_{LB} flowing through the inductor 110 becoming equal to a magnitude of the current i_{LZVS} flowing through the zero-voltage switching inductor 130.

In Mode 1, the first switching device 1211, which is the main switching device in the boost mode, may be in a turn-on state, and the second switching device 1212 may be in a turn-off state. The third switching device 1213 and the fourth switching device 1214, which are not the main switching devices in the boost mode, may be in a turn-off state.

In Mode 1, the magnitude of the current i_{LB} as flowing through the inductor 110 may have a positive slope. The current i_{LZVS} flowing through the zero-voltage switching inductor 130 and the current i_{Q1} flowing through the first switching device 1211 may have a positive slope. In this case, due to a total inductance of the inductor 110 and the zero-voltage switching inductor 130, the slope of the current i_{LZVS} flowing through the zero-voltage switching inductor 130 and the slope of the current i_{Q1} flowing through the first switching device 1211 may become more gradual.

### Description of Second Operating Mode (see FIG. 5)

Referring to FIG. 5, Mode 2 may be initiated in response to turning-off of the first switching device 1211.

In Mode 2, all the switching devices (the first to fourth switching devices) included in the switching module 120 may be in a turn-off state.

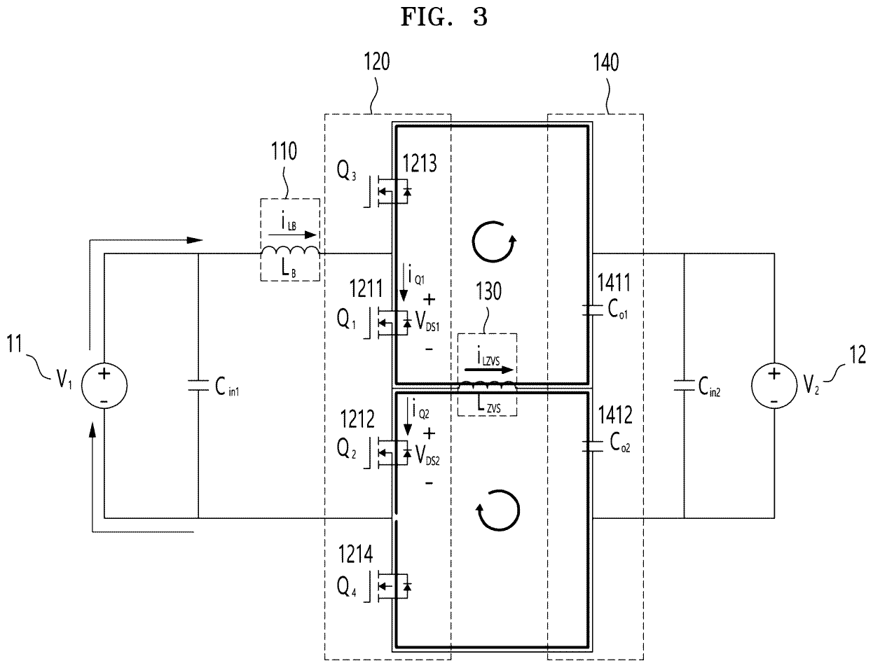

Referring to FIG. 3, based on the turn-off of the first switching device 1211 and the second switching device 1212, the current stored in the zero-voltage switching inductor 130 may flow to the connection point between the first and second output capacitors 1411 and 1412 and flow through the body diode of the fourth switching device 1214 and a body diode of the second switching device 1212.

In Mode 2, the magnitude of the current i_{LB} flowing through the inductor 110 may have a negative slope. The current i_{LZVS} flowing through the zero-voltage switching inductor 130 may have a negative slope. Due to the turn-off of the first switching device 1211, the current i_{Q1} may not flow through the first switching device 1211, and a negative-direction current may flow through the second switching device 1212 due to the zero-voltage switching inductor 130.

### Description of Third Operating Mode (see FIG. 5)

Referring to FIG. 5, Mode 3 may be initiated in response to turn-on of the second switching device 1212.

In Mode 3, the first switching device 1211 may be in a turn-off state, and the second switching device 1212 may be turned on. Further, the third switching device 1213 and the fourth switching device 1214, which are not the main switching devices in the boost mode, may be in a turn-off state.

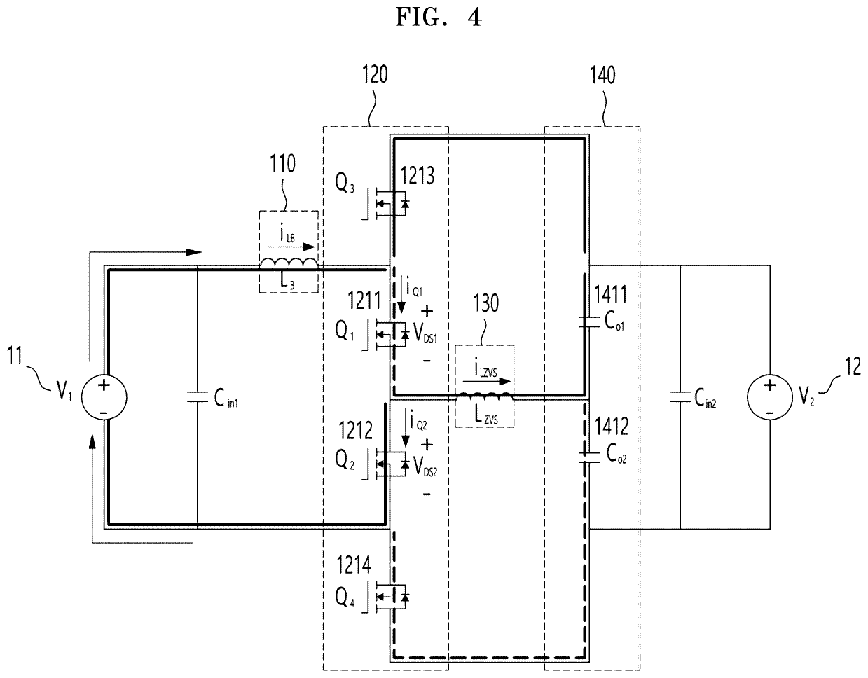

Referring to FIG. 4, based on the turn-on of the second switching device 1212, the current supplied from both ends of the first voltage stage 11 may pass through the inductor 110 and flow to the first output capacitor 1411 through a body diode of the third switching device 1213. Subsequently, the current may pass through the zero-voltage switching inductor 130, flow through the second switching device 1212, and then flow to the negative terminal of the first voltage stage 11.

In Mode 3, the magnitude of the current i_{LB} flowing through the inductor 110 may have a negative slope. The current i_{LZVS} flowing through the zero-voltage switching inductor 130 may have a negative slope. Further, a current i_{Q2} flowing through the second switching device 1212 may have a positive slope. Description of fourth operating mode (see FIG. 5)

Referring to FIG. 5, Mode 4 may be initiated in response to the magnitude of the current i_{LB} flowing through the inductor 110 becoming equal to the magnitude of the current i_{LZVS} flowing through the zero-voltage switching inductor 130.

In Mode 4, the first switching device 1211 may be in a turn-off state, and the second switching device 1212 may be in a turn-on state. Further, the third switching device 1213 and the fourth switching device 1214, which are not the main switching devices, may be in a turn-off state.

In Mode 4, the magnitude of the current i_{LB} flowing through the inductor 110 may have a positive slope. The current i_{LZVS} flowing through the zero-voltage switching inductor 130 may have a negative slope. Further, the current i_{Q2} flowing through the second switching device 1212 may have a positive slope. In this case, due to a total inductance of the inductor 110 and the zero-voltage switching inductor 130, the slope of the current i_{LZVS} flowing through the zero-voltage switching inductor 130 and the slope of the current i_{Q2} flowing through the second switching device 1212 may become more gradual.

### Description of Fifth Operating Mode (see FIG. 5)

Referring to FIG. 5, Mode 5 may be initiated in response to turning-off of the second switching device 1212.

In Mode 5, all the switching devices (the first to fourth switching devices) included in the switching module 120 may be in a turn-off state.

Referring to FIG. 3, based on the turn-off of the first switching device 1211 and the second switching device 1212, the current stored in the zero-voltage switching inductor 130 may flow through a body diode of the first switching device 1211 and the body diode of the second switching device 1212, pass through the first and second output capacitors 1411 and 1412, and then flow to the connection point between the first and second output capacitors 1411 and 1412. For example, the current flow in the fifth operating mode may be in the opposite direction of that in the second operating mode.

In Mode 5, the magnitude of the current (i_{LB} flowing through the inductor 110 may have a negative slope. The current i_{LZVS} flowing through the zero-voltage switching inductor 130 may have a positive slope. Due to the turn-off of the second switching device 1212, the current i_{Q1} may not flow through the second switching device 1212, and a negative-direction current may flow through the first switching device 1211 due to the zero-voltage switching inductor 130.

In some embodiments, at the beginning of Mode 6 and Mode 3, the zero-voltage switching inductor 130 may enable zero-voltage switching of the first switching device 1211 and the second switching device 1212, respectively, thereby allowing the first switching device 1211 and the second switching device 1212 to be turned on.

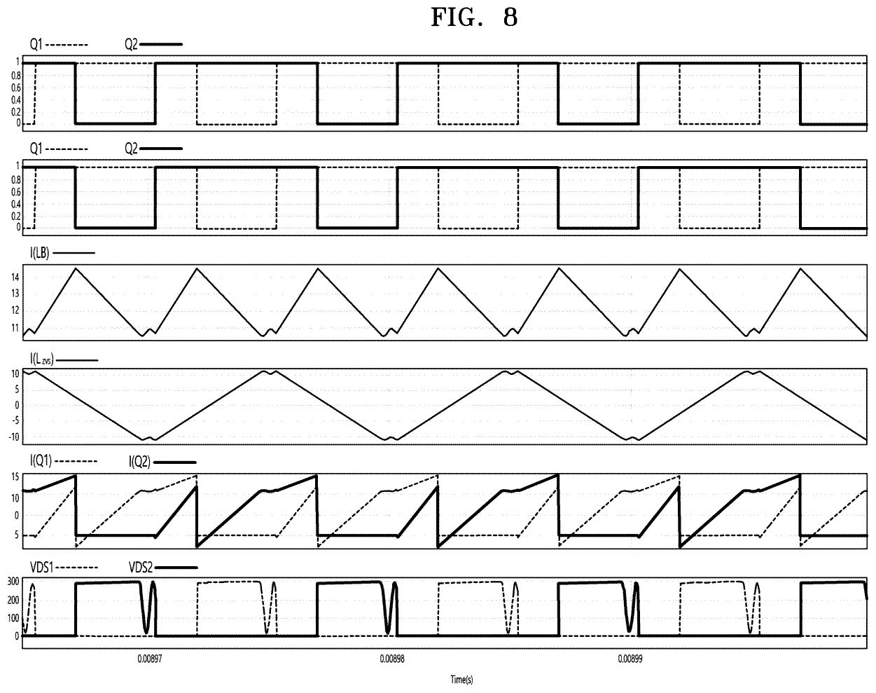

In an embodiment of the present disclosure, even when the duty ratio of each main switching device is greater than 0.5 (that is, when the sum of the duty ratios of the main switching devices is greater than 1), the DC-DC converter may still operate in six operating modes described below, depending on the turn-on or turn-off of the main switching devices. FIG. 7 illustrates an example of waveforms of the DC-DC converter when the duty ratio of each main switching device is greater than 0.5, and FIG. 8 illustrates an example of actual simulation results of the waveforms of the DC-DC converter.

### Description of Fifth Operating Mode (see FIG. 7)

Referring to FIG. 7, Mode 5 may be initiated based on the turn-off of the second switching device 1212. In more detail, in Mode 5, the second switching device 1212 may be in a turn-off state, while the first switching device 1211 remains in the turn-on state.

Further, the third switching device 1213 and the fourth switching device 1214, which are not the main switching devices in the boost mode, may be in a turn-off state.

In Mode 5, the magnitude of the current (i_{LB}) flowing through the inductor 110 may have a negative slope. The current i_{LZVS} flowing through the zero-voltage switching inductor 130 and the current i_{Q1} flowing through the first switching device 1211 may have a positive slope.

### Description of Sixth Operating Mode (see FIG. 7)

Referring to FIG. 7, Mode 6 may be initiated based on the magnitude of the current i_{LB} flowing through the inductor 110 becoming equal to the magnitude of the current i_{LZVS} flowing through the zero-voltage switching inductor 130.

In Mode 6, the first switching device 1211, which is the main switching device in the boost mode, is in a turn-on state, and the second switching device 1212 may be in a turn-off state. Further, the third switching device 1213 and the fourth switching device 1214, which are not the main switching devices in the boost mode, may be in a turn-off state.

In Mode 6, the magnitude of the current i_{LB} flowing through the inductor 110 may have a positive slope. In this case, due to a total inductance of the inductor 110 and the zero-voltage switching inductor 130, the slope of the current may become more gradual. The current i_{LZVS} says flowing through the zero-voltage switching inductor 130 and the current i_{Q1} flowing through the first switching device 1211 may have a positive slope.

Description of first operating mode (see FIG. 7)

Referring to FIG. 7, Mode 1 may be initiated in response to turn-on of the second switching device 1212, while the first switching device 1211 remains in the turn-on state.

In an embodiment, the second switching device 1212 may be turned on under zero-voltage switching conditions in Mode 1.

In Mode 1, the third switching device 1213 and the fourth switching device 1214 may be in a turn-off state.

In Mode 1, the magnitude of the current i_{LB} flowing through the inductor 110 may have a positive slope. The current i_{LZVS} flowing through the zero-voltage switching inductor 130 may have a negative slope. The current i_{Q1} flowing through the first switching device 1211 and the current i_{Q2} flowing through the second switching device 1212 may have a positive slope.

### Description of Second Operating Mode (see FIG. 7)

Referring to FIG. 7, Mode 2 may be initiated based on the turn-off of the first switching device 1211. In more detail, in Mode 2, the first switching device 1211 may be turned off, while the second switching device 1212 remains in the turn-on state.

Further, the third switching device 1213 and the fourth switching device 1214, which are not the main switching devices in the boost mode, may be in a turn-off state.

In Mode 2, the magnitude of the current i_{LB} flowing through the inductor 110 may have a negative slope. The current i_{LZVS} flowing through the zero-voltage switching inductor 130 may have a negative slope. The current i_{Q2} flowing through the second switching device 1212 may have a positive slope.

### Description of Third Operating Mode (see FIG. 7)

Referring to FIG. 7, Mode 3 may be initiated based on the magnitude of the current i_{LB} flowing through the inductor 110 becoming equal to the magnitude of the current i_{LZVS} flowing through the zero-voltage switching inductor 130.

In Mode 3, the first switching device 1211 may be in a turn-off state, and the second switching device 1212 may be in a turn-on state. Further, the third switching device 1213 and the fourth switching device 1214 may be in a turn-off state.

In Mode 3, the magnitude of the current i_{LB} flowing through the inductor 110 may have a positive slope. In this case, due to a total inductance of the inductor 110 and the zero-voltage switching inductor 130, the slope of the current may become more gradual. The current i_{LZVS} flowing through the zero-voltage switching inductor 130 may have a negative slope. The current i_{Q2} flowing through the second switching device 1212 may have a positive slope.

### Description of Fourth Operating Mode (see FIG. 7)

Referring to FIG. 7, Mode 4 may be initiated in response to turn-on of the first switching device 1211, while the second switching device 1212 remains in the turn-on state. In an embodiment, the first switching device 1211 may be turned on under zero-voltage switching conditions in Mode 4.

In Mode 4, the third switching device 1213 and the fourth switching device 1214 may be in a turn-off state.

In Mode 4, the magnitude of the current i_{LB} flowing through the inductor 110 may have a positive slope. The current i_{LZVS} flowing through the zero-voltage switching inductor 130 may have a positive slope. The current i_{Q1} flowing through the first switching device 1211 and the current i_{Q2} flowing through the second switching device 1212 may have a positive slope.

FIG. 8 is an example of actual simulation results for the waveforms (see FIG. 7) of the DC-DC converter operating in the boost mode, according to an embodiment of the present disclosure.

In the operating mode in which the duty ratio of each of the main switching devices (the first switching device 1211 and the second switching device 1212) is greater than 0.5, the second switching device 1212 at the beginning of Mode 1 and the first switching device 1211 at the beginning of Mode 4 may achieve zero-voltage switching and be turned on due to the zero-voltage switching inductor 130.

In some embodiments, the current flow in each of the six operating modes of the DC-DC converter (when the duty ratio of each main switching device is greater than 0.5) can be understood by referring to the current flows described with reference to FIGS. 2 to 4. For example, since FIG. 2 illustrates the current flow when the first switching device 1211 is in a turn-on state, FIG. 3 illustrates the current flow when both the first switching device 1211 and the second switching device 1212 are in a turn-off state, and FIG. 4 illustrates the current flow when the second switching device 1212 is in a turn-on state, the current flow in each of the six operating modes described above may be generated by superimposing the current flows corresponding to the turn-on states of the respective main switching devices.

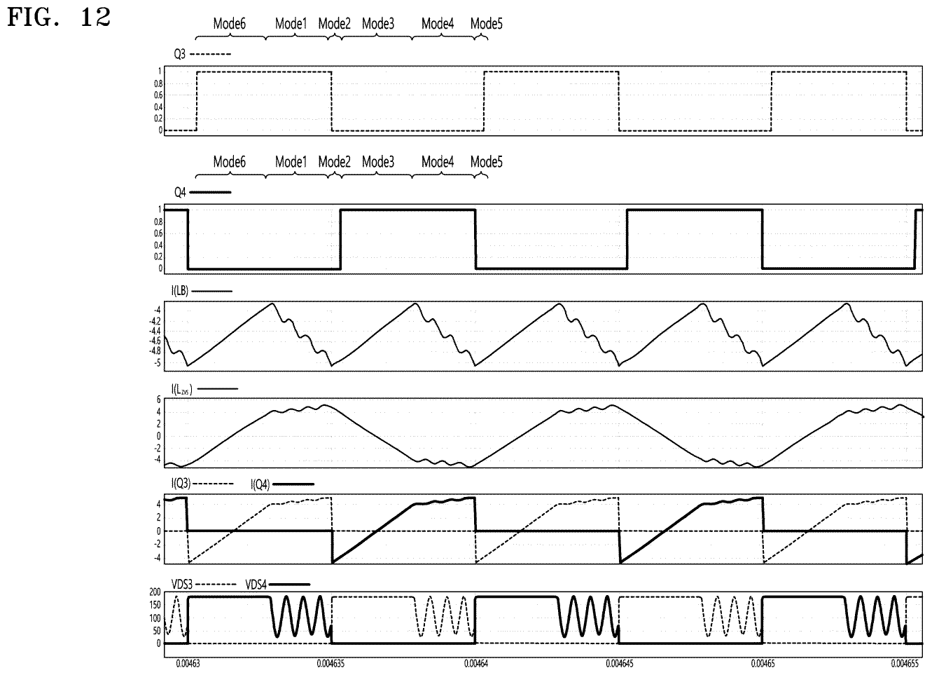

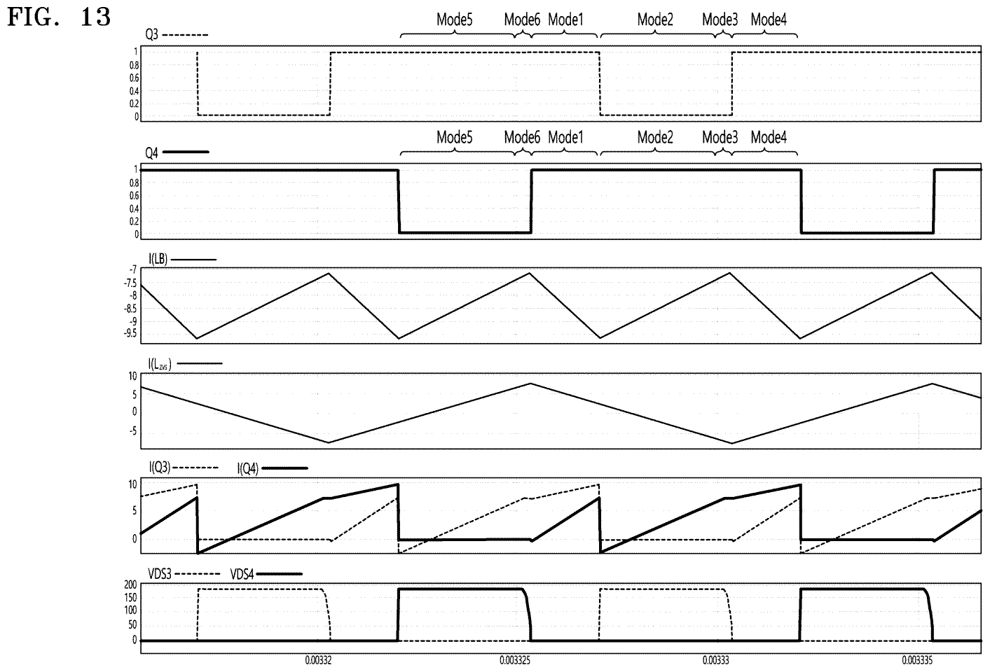

FIGS. 9 to 13 are diagrams for describing a case in which the DC-DC converter operates in the buck mode, in an embodiment of the present disclosure. FIGS. 9 to 11 are diagrams for describing examples of current flow, and FIGS. 12 and 13 are diagrams for describing examples of waveforms of the DC-DC converter.

In the present disclosure, the DC-DC converter 1 operating in the buck mode may operate in six operating modes depending on turn-on or turn-off of the main switching devices.

In more detail, FIG. 12 illustrates waveforms of the DC-DC converter (as an example of actual simulation results) in a case in which the duty ratio of each main switching device is less than 0.5 (that is, when the sum of the duty ratios of the main switching devices is less than 1), and FIG. 13 illustrates waveforms of the DC-DC converter (as an example of actual simulation results) when the duty ratio of each main switching device is greater than 0.5 (that is, when the sum of the duty ratios of the main switching devices is greater than 1).

Referring to FIG. 12, the operating modes when the duty ratio of each main switching device is less than 0.5 will be described first.

The case in which the DC-DC converter operates in the sixth operating mode (Mode 6) will be described (see FIG. 12).

Referring to FIG. 12, Mode 6 may be initiated based on the turn-on of the third switching device 1213.

In Mode 6, the third switching device 1213, which is the main switching device in the buck mode, may be turned on, and the fourth switching device 1214 may be in a turn-off state. The first switching device 1211 and the second switching device 1212, which are not the main switching devices in the buck mode, may be in a turn-off state.

Referring to FIG. 9, based on the turn-on of the third switching device 1213, the current supplied from both ends of the second voltage stage 12 may pass through the third switching device 1213, flow through the zero-voltage switching inductor 130, and then flow to the first voltage stage 11. Thereafter, the current may pass through the body diode of the second switching device 1212, flow through the zero-voltage switching inductor 130, and then flow to a negative terminal of the second voltage stage 12.

In Mode 6, the magnitude of the current i_{LB} flowing through the inductor 110 may have a negative slope. The current i_{LZVS} flowing through the zero-voltage switching inductor 130 and the current i_{Q3} flowing through the third switching device 1213 may have a positive slope.

### Description of First Operating Mode (see FIG. 12)

Referring to FIG. 12, Mode 1 may be initiated based on the magnitude of the current i_{LB} flowing through the inductor 110 becoming equal to the magnitude of the current i_{LZVS} flowing through the zero-voltage switching inductor 130.

In Mode 1, the third switching device 1213, which is the main switching device in the buck mode, may be in a turn-on state, and the fourth switching device 1214 may be in a turn-off state. The first switching device 1211 and the second switching device 1212 may be in a turn-off state.

In Mode 1, the magnitude of the current i_{LB} flowing through the inductor 110 may have a positive slope. The current i_{LZVS} flowing through the zero-voltage switching inductor 130 and the current i_{Q3} flowing through the third switching device 1213 may have a positive slope. In this case, due to a total inductance of the inductor 110 and the zero-voltage switching inductor 130, the slope of the current i_{LZVS} flowing through the zero-voltage switching inductor 130 and the slope of the current i_{Q3} flowing through the third switching device 1213 may become more gradual.

### Description of Second Operating Mode (see FIG. 12)

Referring to FIG. 12, Mode 2 may be initiated in response to turning-off of the third switching device 1213.

In Mode 2, all the switching devices (the first to fourth switching devices) included in the switching module 120 may be in a turn-off state.

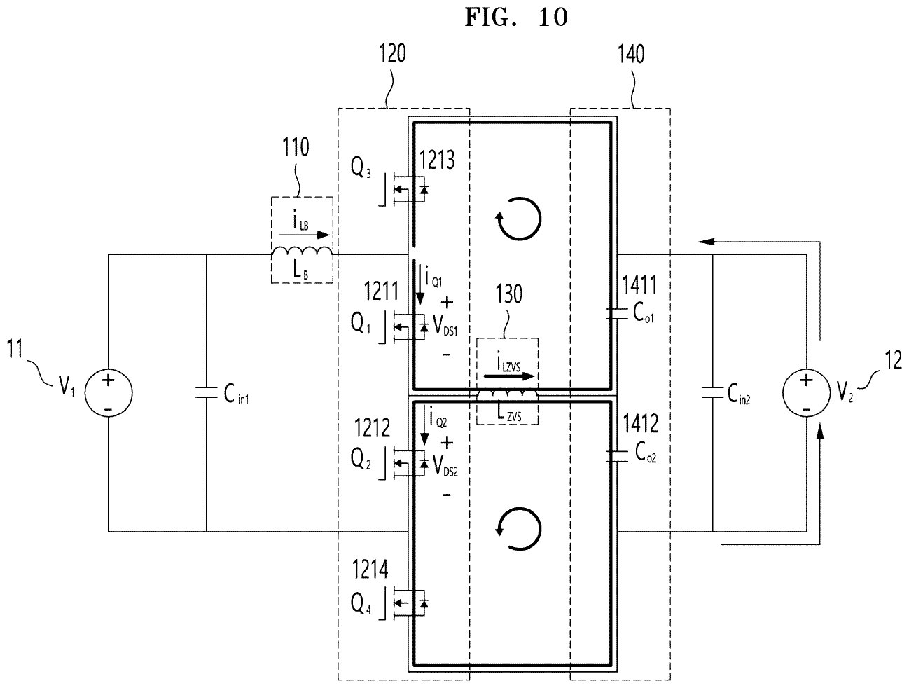

Referring to FIG. 10, based on the turn-off of the third switching device 1213 and the fourth switching device 1214, the current flowing through the zero-voltage switching inductor 130 in the first operating mode may flow through the body diodes of the fourth switching device 1214 and the second switching device 1212.

In Mode 2, the magnitude of the current i_{LB} flowing through the inductor 110 may have a negative slope. The current i_{LZVS} flowing through the zero-voltage switching inductor 130 may have a negative slope. Due to the turn-off of the third switching device 1213, the current i_{Q3} may not flow through the third switching device 1213, and a negative-direction current may flow through the fourth switching device 1214 due to the zero-voltage switching inductor 130.

### Description of Third Operating Mode (see FIG. 12)

Referring to FIG. 12, Mode 3 may be initiated in response to turn-on of the fourth switching device 1214.

In Mode 3, the third switching device 1213 may be in a turn-off state, and the fourth switching device 1214 may be turned on. The first switching device 1211 and the second switching device 1212, which are not the main switching devices, may be in a turn-off state.

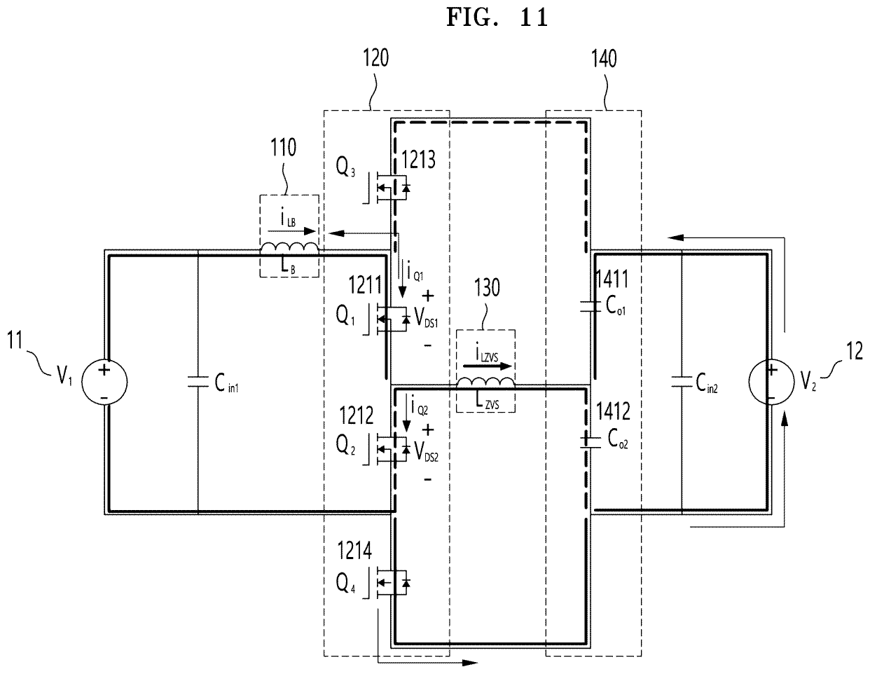

Referring to FIG. 11, based on the turn-on of the fourth switching device 1214, the current supplied from both ends of the second voltage stage 12 may flow through the zero-voltage switching inductor 130, the body diode of the first switching device 1211, and the inductor 110, and then flow to the first voltage stage 11. Subsequently, the current may pass through the fourth switching device 1214 and flow to the negative terminal of the second voltage stage 12.

In Mode 3, the magnitude of the current i_{LB} flowing through the inductor 110 has a negative slope. The current i_{LZVS} flowing through the zero-voltage switching inductor 130 may have a negative slope. Further, the current i_{Q4} flowing through the fourth switching device 1214 may have a positive slope.

### Description of Fourth Operating Mode (see FIG. 12)

Referring to FIG. 12, Mode 4 may be initiated in response to the magnitude of the current i_{LB} flowing through the inductor 110 becoming equal to the magnitude of the current i_{LZVS} flowing through the zero-voltage switching inductor 130.

In Mode 4, the third switching device 1213 may be in a turn-off state, and the fourth switching device 1214 may be in a turn-on state. The first switching device 1211 and the second switching device 1212 may be in a turn-off state.

In Mode 4, the magnitude of the current i_{LB} flowing through the inductor 110 may have a positive slope. The current i_{LZVS} flowing through the zero-voltage switching inductor 130 may have a negative slope. Further, the current i_{Q4} flowing through the fourth switching device 1214 may have a positive slope. In this case, due to a total inductance of the inductor 110 and the zero-voltage switching inductor 130, the slope of the current i_{LZVS} flowing through the zero-voltage switching inductor 130 and the slope of the current i_{Q4} flowing through the fourth switching device 1214 may become more gradual.

### Description of Fifth Operating Mode (see FIG. 12)

Referring to FIG. 12, Mode 5 may be initiated in response to turning-off of the fourth switching device 1214.

In Mode 5, all the switching devices (the first to fourth switching devices) included in the switching module 120 may be in a turn-off state.

Referring to FIG. 10, based on the turn-off of the third switching device 1213 and the fourth switching device 1214, the current flowing through the zero-voltage switching inductor 130 in the first operating mode may flow through the body diodes of the first switching device 1211 and the third switching device 1213.

In Mode 5, the magnitude of the current i_{LB} flowing through the inductor 110 may have a negative slope. The current i_{LZVS} flowing through the zero-voltage switching inductor 130 may have a positive slope. Due to the turn-off of the fourth switching device 1214, the current i_{Q4} may not flow through the fourth switching device 1214, and a negative-direction current may flow through the third switching device 1213 due to the zero-voltage switching inductor 130.

In some embodiments, at the beginning of Mode 6 and Mode 3, the zero-voltage switching inductor 130 may enable zero-voltage switching of the third switching device 1213 and the fourth switching device 1214, respectively, thereby allowing the third switching device 1213 and the fourth switching device 1214 to be turned on.

Referring to FIG. 13, the operating modes when the duty ratio of each main switching device is greater than 0.5 will be described.

### Description of Fifth Operating Mode (see FIG. 13)

Referring to FIG. 13, Mode 5 may be initiated based on the turn-off of the fourth switching device 1214. Specifically, in Mode 5, the fourth switching device 1214 may be in a turn-off state, while the third switching device 1213 remains in the turn-on state.

The first switching device 1211 and the second switching device 1212, which are not the main switching devices in the buck mode, may be in a turn-off state.

In Mode 5, the magnitude of the current zs flowing through the inductor 110 may have a negative slope. The current says flowing through the zero-voltage switching inductor 130 and the current flowing through the third switching device 1213 may have a positive slope.

### Description of Sixth Operating Mode (see FIG. 13)

Referring to FIG. 13, Mode 6 may be initiated based on the magnitude of the current i_{LB} flowing through the inductor 110 becoming equal to the magnitude of the current i_{LZVS} flowing through the zero-voltage switching inductor 130.

In Mode 6, the third switching device 1213, which is the main switching device, may be in a turn-on state, and the fourth switching device 1214 may be in a turn-off state. The first switching device 1211 and the second switching device 1212, which are not the main switching devices, may be in a turn-off state.

In Mode 6, the magnitude of the current i_{LB} flowing through the inductor 110 may have a positive slope. In this case, due to a total inductance of the inductor 110 and the zero-voltage switching inductor 130, the slope of the current may become more gradual. The current i_{LZVS} flowing through the zero-voltage switching inductor 130 and the current i_{q3} flowing through the third switching device 1213 may have a positive slope.

### Description of First Operating Mode (see FIG. 13)

Referring to FIG. 13, Mode 1 may be initiated in response to turn-on of the fourth switching device 1214, while the third switching device 1213 remains in the turn-on state. In an embodiment, the fourth switching device 1214 may be turned on under zero-voltage switching conditions in Mode 1.

In Mode 1, the first switching device 1211 and the second switching device 1212 may be in a turn-off state.

In Mode 1, the magnitude of the current i_{LB} flowing through the inductor 110 may have a positive slope. The current i_{LZVS} flowing through the zero-voltage switching inductor 130 may have a negative slope. The current i_{Q3} flowing through the third switching device 1213 and the current i_{Q4} flowing through the fourth switching device 1214 may have a positive slope.

### Description of Second Operating Mode (see FIG. 13)

Referring to FIG. 13, Mode 2 may be initiated based on the turn-off of the third switching device 1213. In more detail, in Mode 2, the third switching device 1213 may be turned off, while the fourth switching device 1214 remains in the turn-on state.

The first switching device 1211 and the second switching device 1212, which are not the main switching devices, may be in a turn-off state.

In Mode 2, the magnitude of the current i_{LB} flowing through the inductor 110 may have a negative slope. The current i_{LZVS} flowing through the zero-voltage switching inductor 130 may have a negative slope. The current i_{Q4} flowing through the fourth switching device 1214 may have a positive slope.

Description of third operating mode (see FIG. 13)

Referring to FIG. 13, Mode 3 may be initiated based on the magnitude of the current i_{LB} flowing through the inductor 110 becoming equal to the magnitude of the current i_{LZVS} flowing through the zero-voltage switching inductor 130.

In Mode 3, the third switching device 1213 may be in a turn-off state, and the fourth switching device 1214 may be in a turn-on state. The first switching device 1211 and the second switching device 1212 may be in a turn-off state.

In Mode 3, the magnitude of the current i_{LB} flowing through the inductor 110 may have a positive slope. In this case, due to a total inductance of the inductor 110 and the zero-voltage switching inductor 130, the slope of the current may become more gradual. The current i_{LZVS} flowing through the zero-voltage switching inductor 130 may have a negative slope. The current i_{Q4} flowing through the fourth switching device 1214 may have a positive slope.

### Description of Fourth Operating Mode (see FIG. 13)

Referring to FIG. 13, Mode 4 may be initiated in response to turn-on of the third switching device 1213, while the fourth switching device 1214 remains in the turn-on state. In an embodiment, the third switching device 1213 may be turned on under zero-voltage switching conditions in Mode 4.

In Mode 4, the first switching device 1211 and the second switching device 1212 may be in a turn-off state.

In Mode 4, the magnitude of the current i_{LB} flowing through the inductor 110 may have a positive slope. The current i_{LZVS} flowing through the zero-voltage switching inductor 130 may have a positive slope. The current i_{Q3} flowing through the third switching device 1213 and the current i_{Q4} flowing through the fourth switching device 1214 may have a positive slope.

In some embodiments, in the operating mode in which the duty ratio of each of the main switching devices (the third switching device 1213 and the fourth switching device 1214) is greater than 0.5, the fourth switching device 1214 at the beginning of Mode 1 and the third switching device 1213 at the beginning of Mode 4 may achieve zero-voltage switching and be turned on due to the zero-voltage switching inductor 130.

In some embodiments, the current flow in each of the six operating modes of the DC-DC converter (when the duty ratio of each main switching device is greater than 0.5) can be understood by referring to the current flows described with reference to FIGS. 9 to 11. For example, since FIG. 9 illustrates the current flow when the third switching device 1213 is in a turn-on state, FIG. 10 illustrates the current flow when both the third switching device 1213 and the fourth switching device 1214 are in a turn-off state, and FIG. 11 illustrates the current flow when the fourth switching device 1214 is in a turn-on state, the current flow in each of the six operating modes described above may be generated by superimposing the current flows corresponding to the turn-on states of the respective main switching devices.

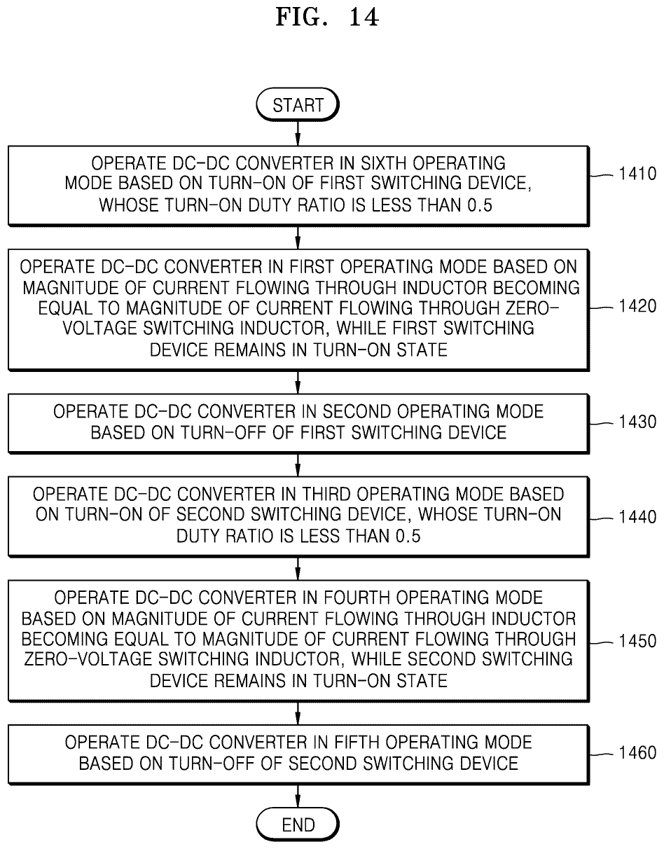

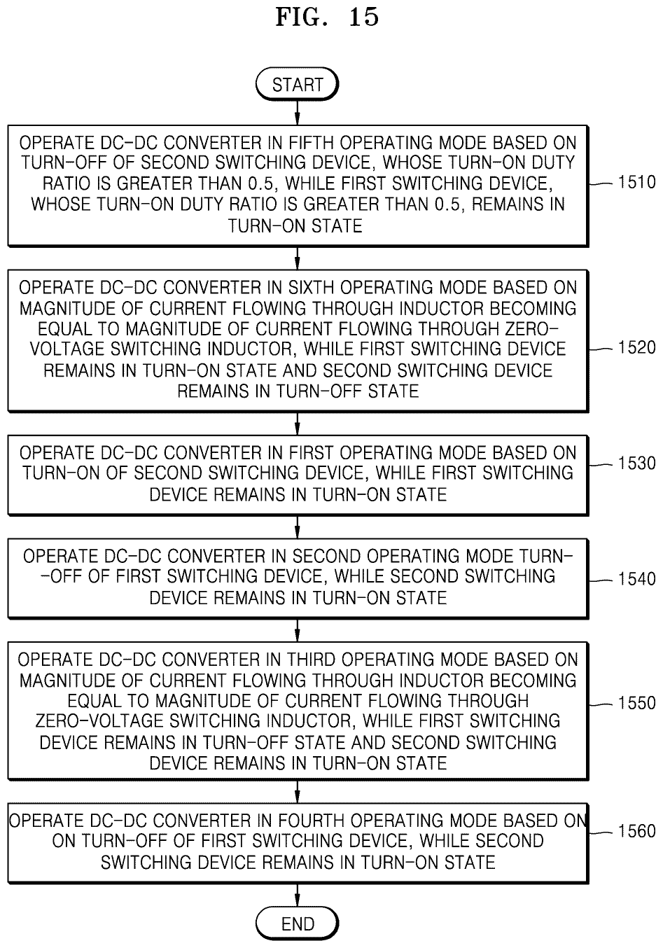

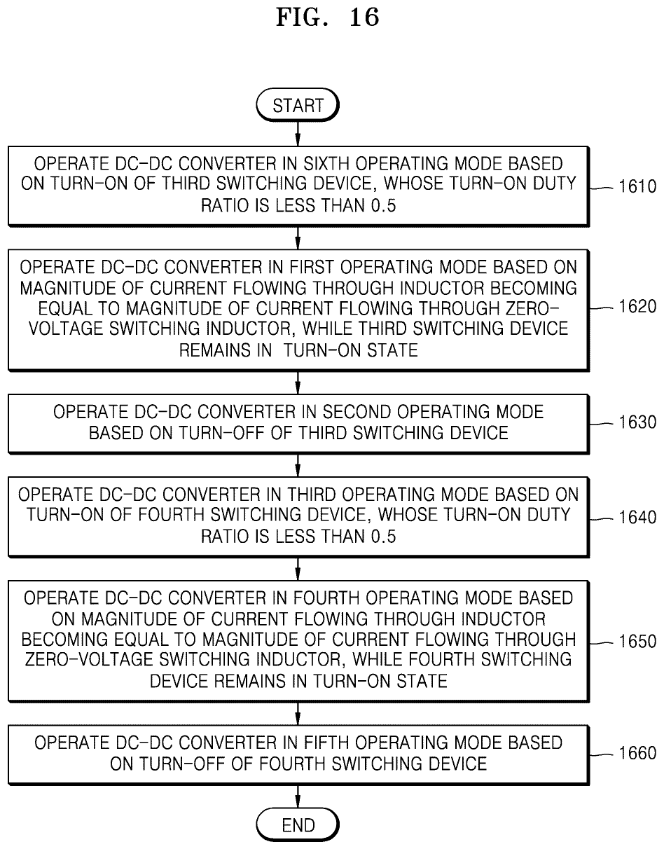

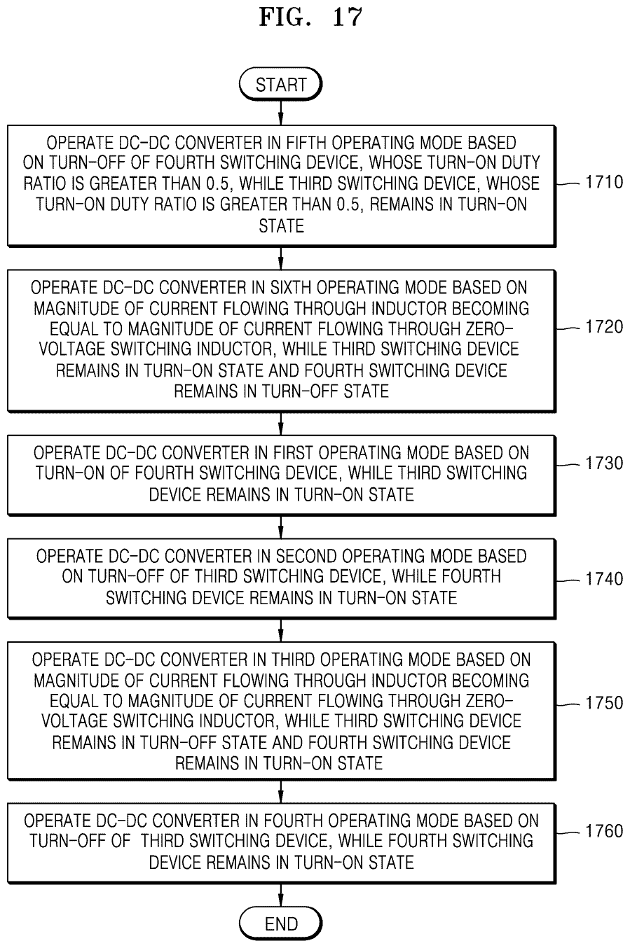

FIGS. 14 to 17 are flowcharts for describing embodiments of methods of operating the DC-DC converter in the present disclosure. In more detail, FIG. 14 is a diagram for describing a method of operating the DC-DC converter when a duty ratio of the main switching device is less than 0.5 while operating the DC-DC converter in a boost mode, and FIG. 15 is a diagram for describing a method of operating the DC-DC converter when the duty ratio of the main switching device is greater than 0.5 while operating the DC-DC converter in the boost mode. Further, FIG. 16 is a diagram for describing a method of operating the DC-DC converter when the duty ratio of the main switching device is less than 0.5 while operating the DC-DC converter in a buck mode, and FIG. 17 is a diagram for describing a method of operating the DC-DC converter when the duty ratio of the main switching device is greater than 0.5 while operating the DC-DC converter in the buck mode.

Hereinafter, redundant descriptions of the DC-DC converter in the content described with reference to FIGS. 14 to 17 will be omitted.

Referring to FIG. 14, in operation 1410, the DC-DC converter operating in a boost mode may operate in a sixth operating mode based on turn-on of the first switching device, whose turn-on duty ratio is less than 0.5.

In operation 1420, the DC-DC converter may operate in a first operating mode based on a magnitude of a current flowing through the inductor becoming equal to a magnitude of a current flowing through the zero-voltage switching inductor, while the first switching device remains in the turn-on state.

In operation 1430, the DC-DC converter may operate in a second operating mode based on turn-off of the first switching device.

In operation 1440, the DC-DC converter may operate in a third operating mode based on turn-on of the second switching device, whose duty ratio is less than 0.5.

In operation 1450, the DC-DC converter may operate in a fourth operating mode based on the magnitude of the current flowing through the inductor becoming equal to the magnitude of the current flowing through the zero-voltage switching inductor, while the second switching device remains in the turn-on state.

In operation 1460, the DC-DC converter may operate in a fifth operating mode based on turn-off of the second switching device.

Referring to FIG. 15, in operation 1510, the DC-DC converter operating in the boost mode may operate in the fifth operating mode based on turn-on of the second switching device, whose duty ratio is greater than 0.5, while the first switching device, whose turn-on duty ratio is greater than 0.5, remains in the turn-on state.

In operation 1520, the DC-DC converter may operate in the sixth operating mode based on the magnitude of the current flowing through the inductor becoming equal to the magnitude of the current flowing through the zero-voltage switching inductor, while the first switching device remains in the turn-on state and the second switching device remains in the turn-off state.

In operation 1530, the DC-DC converter may operate in the first operating mode based on turn-on of the second switching device, while the first switching device remains in the turn-on state.

In operation 1540, the DC-DC converter may operate in the second operating mode based on turn-off of the first switching device, while the second switching device remains in the turn-on state.

In operation 1550, the DC-DC converter may operate in the third operating mode based on the magnitude of the current flowing through the inductor becoming equal to the magnitude of the current flowing through the zero-voltage switching inductor, while the first switching device remains in the turn-off state and the second switching device remains in the turn-on state.

In operation 1560, the DC-DC converter may operate in the fourth operating mode based on turn-on of the first switching device, while the second switching device remains in the turn-on state.

Referring to FIG. 16, in operation 1610, the DC-DC converter operating in a buck mode may operate in a sixth operating mode based on turn-on of the third switching device, whose turn-on duty ratio is less than 0.5.

In operation 1620, the DC-DC converter may operate in a first operating mode based on a magnitude of a current flowing through the inductor becoming equal to a magnitude of a current flowing through the zero-voltage switching inductor, while the third switching device remains in the turn-on state.

In operation 1630, the DC-DC converter may operate in a second operating mode based on turn-off of the third switching device.

In operation 1640, the DC-DC converter may operate in a third operating mode based on turn-on of the fourth switching device, whose duty ratio is less than 0.5.

In operation 1650, the DC-DC converter may operate in a fourth operating mode based on the magnitude of the current flowing through the inductor becoming equal to the magnitude of the current flowing through the zero-voltage switching inductor, while the fourth switching device remains in the turn-on state.

In operation 1660, the DC-DC converter may operate in a fifth operating mode based on turn-off of the fourth switching device.

Referring to FIG. 17, in operation 1710, the DC-DC converter operating in the buck mode may operate in the fifth operating mode based on turn-on of the fourth switching device, whose duty ratio is greater than 0.5, while the third switching device, whose turn-on duty ratio is greater than 0.5, remains in the turn-on state.

In operation 1720, the DC-DC converter may operate in the sixth operating mode based on the magnitude of the current flowing through the inductor becoming equal to the magnitude of the current flowing through the zero-voltage switching inductor, while the third switching device remains in the turn-on state and the fourth switching device remains in the turn-off state.

In operation 1730, the DC-DC converter may operate in the first operating mode based on turn-on of the fourth switching device, while the third switching device remains in the turn-on state.

In operation 1740, the DC-DC converter may operate in the second operating mode based on turn-off of the third switching device, while the fourth switching device remains in the turn-on state.

In operation 1750, the DC-DC converter may operate in the third operating mode based on the magnitude of the current flowing through the inductor becoming equal to the magnitude of the current flowing through the zero-voltage switching inductor, while the third switching device remains in the turn-off state and the fourth switching device remains in the turn-on state.

In operation 1760, the DC-DC converter may operate in the fourth operating mode based on turn-on of the third switching device, while the fourth switching device remains in the turn-on state.

According to the problem-solving means of the present disclosure described above, a bidirectional DC-DC converter capable of enhancing efficiency through a zero-voltage switching method can be provided.

According to the problem-solving means of the present disclosure described above, a bidirectional DC-DC converter that is effective in reducing electromagnetic interference (EMI) by minimizing switching noise can be provided.

The effects according to embodiments are not limited to the above-mentioned effects, and other effects not mentioned may be clearly understood by those skilled in the art from the description of the present specification.

Meanwhile, the embodiments according to the present disclosure may be implemented in the form of a computer program that can be executed through various components on a computer, and such a computer program may be recorded on a computer-readable medium. Here, the medium may include hardware devices specially configured to store and execute program instructions, including magnetic media such as a hard disk, a floppy disk, and a magnetic tape, optical media such as a compact disc read-only memory (CD-ROM) and a digital versatile disk (DVD), magneto-optical media such as a floptical disk, and solid state drives such as a read-only memory (ROM), a random access memory (RAM), and a flash memory, but the present disclosure is not limited thereto.

The computer program may be a program specially designed and configured for the present disclosure or a program known and usable to those skilled in the computer software field. Examples of the computer program include machine language codes generated by a compiler as well as high-level language codes that are executable by a computer using an interpreter or the like.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Operations of all methods described herein can be performed in any suitable order unless otherwise indicated herein or otherwise clearly contradicted by context. The present disclosure is not limited to the described order of the operations. The use of any and all examples, or exemplary terms (e.g., “such as”) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

It should be noted that the spirit of the present disclosure is not limited to the embodiments described above, and not only the claims to be described below, but also all ranges equivalent to or equivalently changed from the claims fall within the scope of the spirit of the present disclosure.

What is claimed is:

1. A bidirectional non-isolated direct current-to-direct current (DC-DC) converter comprising:
a first voltage stage configured to generate a first voltage;
a second voltage stage configured to generate a voltage higher than the first voltage;
an inductor connected to the first voltage stage;
a switching module including four switching devices connected in series, and configured to generate a three-level voltage through selective switching operations of each of the four switching devices;
a zero-voltage switching inductor configured to induce zero-voltage switching of main switching devices included in the switching module; and
an output capacitor module connected to the second voltage stage and configured to halve the output voltage.

2. The bidirectional non-isolated DC-DC converter of claim 1, wherein the zero-voltage switching inductor has one end connected to a connection point between output capacitors included in the output capacitor module, and another end connected to a connection point between a first switching device and a second switching device, which are included in the switching module.

3. The bidirectional non-isolated DC-DC converter of claim 1, wherein the inductor has one end connected to the first voltage stage, and another end connected to a connection point between a first switching device and a third switching device, which are included in the switching module.

4. The bidirectional non-isolated DC-DC converter of claim 1, wherein, based on the bidirectional non-isolated DC-DC converter operating in a boost mode, a first switching device and a second switching device, which are included in the switching module, operate as the main switching devices.

5. The bidirectional non-isolated DC-DC converter of claim 4, wherein
based on a sum of a duty ratio at which the first switching device turns on and a duty ratio at which the second switching device turns on being less than 1,
the first switching device turns on in a first operating mode, turns off in a second operating mode, turns off in a third operating mode, turns off in a fourth operating mode, turns off in a fifth operating mode, and turns on in a sixth operating mode, and
the second switching device turns off in the first operating mode, turns off in the second operating mode, turns on in the third operating mode, turns on in the fourth operating mode, turns off in the fifth operating mode, and turns off in the sixth operating mode.

6. The bidirectional non-isolated DC-DC converter of claim 5, wherein
in the sixth operating mode, the first switching device achieves the zero-voltage switching and turns on, and
in the third operating mode, the second switching device achieves the zero-voltage switching and turns on.

7. The bidirectional non-isolated DC-DC converter of claim 4, wherein
based on a sum of a duty ratio at which the first switching device turns on and a duty ratio at which the second switching device turns on being greater than 1,
the first switching device turns on in a first operating mode, turns off in a second operating mode, turns off in a third operating mode, turns on in a fourth operating mode, turns on in a fifth operating mode, and turns on in a sixth operating mode, and
the second switching device turns on in the first operating mode, turns on in the second operating mode, turns on in the third operating mode, turns on in the fourth operating mode, turns off in the fifth operating mode, and turns off in the sixth operating mode.

8. The bidirectional non-isolated DC-DC converter of claim 7, wherein
in the fourth operating mode, the first switching device achieves the zero-voltage switching and turns on, and
in the first operating mode, the second switching device achieves the zero-voltage switching and turns on.

9. The bidirectional non-isolated DC-DC converter of claim 1, wherein, based on the bidirectional non-isolated DC-DC converter operating in a buck mode, a third switching device and a fourth switching device, which are included in the switching module, operate as the main switching devices.

10. The bidirectional non-isolated DC-DC converter of claim 9, wherein
based on a sum of a duty ratio at which the third switching device turns on and a duty ratio at which the fourth switching device turns on being less than 1,
the third switching device turns on in a first operating mode, turns off in a second operating mode, turns off in a third operating mode, turns off in a fourth operating mode, turns off in a fifth operating mode, and turns on in a sixth operating mode, and
the fourth switching device turns off in the first operating mode, turns off in the second operating mode, turns on in the third operating mode, turns on in the fourth operating mode, turns off in the fifth operating mode, and turns off in the sixth operating mode.

11. The bidirectional non-isolated DC-DC converter of claim 10, wherein
in the sixth operating mode, the third switching device achieves the zero-voltage switching and turns on, and
in the third operating mode, the fourth switching device achieves the zero-voltage switching and turns on.

12. The bidirectional non-isolated DC-DC converter of claim 9, wherein
based on a sum of a duty ratio at which the third switching device turns on and a duty ratio at which the fourth switching device turns on being greater than 1,
the third switching device turns on in a first operating mode, turns off in a second operating mode, turns off in a third operating mode, turns on in a fourth operating mode, turns on in a fifth operating mode, and turns on in a sixth operating mode, and
the fourth switching device turns on in the first operating mode, turns on in the second operating mode, turns on in the third operating mode, turns on in the fourth operating mode, turns off in the fifth operating mode, and turns off in the sixth operating mode.

13. The bidirectional non-isolated DC-DC converter of claim 12, wherein
in the fourth operating mode, the third switching device achieves the zero-voltage switching and turns on, and
in the first operating mode, the fourth switching device achieves the zero-voltage switching and turns on.

14. A method of operating a bidirectional non-isolated direct current-to-direct current (DC-DC) converter operating in a boost mode, the method comprising:
operating the bidirectional non-isolated DC-DC converter in a sixth operating mode based on turn-on of a first switching device that has a turn-on duty ratio of less than 0.5;
operating the bidirectional non-isolated DC-DC converter in a first operating mode based on a magnitude of a current flowing through an inductor becoming equal to a magnitude of a current flowing through a zero-voltage switching inductor, while the first switching device remains turned on;
operating the bidirectional non-isolated DC-DC converter in a second operating mode based on turn-off of the first switching device;
operating the bidirectional non-isolated DC-DC converter in a third operating mode based on turn-on of a second switching device that has the turn-on duty ratio of less than 0.5;
operating the bidirectional non-isolated DC-DC converter in a fourth operating mode based on the magnitude of the current flowing through the inductor becoming equal to the magnitude of the current flowing through a zero-voltage switching inductor, while the second switching device remains turned on; and
operating the bidirectional non-isolated DC-DC converter in a fifth operating mode based on turn-off of the second switching device.

15. A method of operating a bidirectional non-isolated direct current-to-direct current (DC-DC) converter operating in a boost mode, the method comprising:
operating the bidirectional non-isolated DC-DC converter in a fifth operating mode based on turn-off of a first switching device having a turn-on duty ratio of greater than 0.5, while a second switching device having the turn-on duty ratio of greater than 0.5 is in a turn-on state;
operating the bidirectional non-isolated DC-DC converter in a sixth operating mode based on a magnitude of a current flowing through an inductor becoming equal to a magnitude of a current flowing through a zero-voltage switching inductor, while the first switching device is in the turn-on state and the second switching device is in a turn-off state;
operating the bidirectional non-isolated DC-DC converter in a first operating mode based on turn-on of the second switching device, while the first switching device is in the turn-on state;
operating the bidirectional non-isolated DC-DC converter in a second operating mode based on turn-off of the first switching device, while the second switching device is in the turn-on state;
operating the bidirectional non-isolated DC-DC converter in a third operating mode based on the magnitude of the current flowing through the inductor becoming equal to the magnitude of the current flowing through the zero-voltage switching inductor, while the first switching device is in the turn-off state and the second switching device is in the turn-on state; and
operating the bidirectional non-isolated DC-DC converter in a fourth operating mode based on turn-on of the first switching device, while the second switching device is in the turn-on state.
